(19) United States
(12) Patent Application Publication
(10) Pub. No.: US 2025/0205021 A1
(43) Pub. Date: Jun. 26, 2025

(54) DENTAL IMPLANTS WITH VARYING DIAMETERS AND ALTERNATING CONCAVE/CONVEX THREAD TYPES

(71) Applicant: RTG Scientific, LLC, Austin, TX (US)

(72) Inventors: Richard Justin HYER, Hyrum, UT (US); Andrew R. FAUTH, North Logan, UT (US)

(21) Appl. No.: 19/002,614

(22) Filed: Dec. 26, 2024

Related U.S. Application Data
(60) Provisional application No. 63/614,879, filed on Dec. 26, 2023.
(60) Provisional application No. 63/569,174, filed on Mar. 24, 2024.

(51) Int. Cl. A61C 8/00

(52) U.S. Cl. CPC A61C 8/0025

(57) ABSTRACT

A threaded dental implant may include a fastener body defining a longitudinal axis. The fastener body may include a proximal end including a threaded socket, a distal end, and a first helical thread disposed about the fastener body along the longitudinal axis. The first helical thread may include a first thread form including a first distal-facing side and a first proximal-facing side, and a second thread form including a second distal-facing side and a second proximal-facing side. The first distal-facing side and the second proximal-facing side may be generally concave. The first proximal-facing side and the second distal-facing side may be generally convex, and the threaded socket may be configured to receive a dental component.

### CROSS-REFERENCE TO RELATED APPLICATIONS

This application claims the benefit of U.S. Provisional Patent Application Ser. No. 63/614,879 filed on Dec. 26, 2023, entitled “DENTAL IMPLANTS WITH VARYING DIAMETERS AND ALTERNATING CONCAVE/CONVEX THREAD TYPES”. This application also claims the benefit of U.S. Provisional Patent Application Ser. No. 63/569,174 filed on Mar. 24, 2024, entitled “ENHANCED SYSTEMS AND METHODS FOR MANUFACTURING UNDERCUT FASTENER THREADFORMS”. The foregoing documents are hereby incorporated by reference in their entirety.

### TECHNICAL FIELD

The present disclosure relates to threaded dental implants. More specifically, the present disclosure relates to dental implants with varying diameters and alternating concave/convex thread types.

### BACKGROUND

Modern dental implants are typically designed to integrate with the jawbone through a process known as osseointegration, which ensures long-term stability and durability. Threaded dental implants are among the most commonly used designs due to their ability to provide mechanical stability during initial placement and to promote favorable load distribution to the surrounding bone tissue.

The threads on dental implants play a critical role in their performance. Traditional thread forms often focus on maximizing primary stability by engaging the bone during placement. However, these designs may generate excessive stresses in the bone, leading to micro-damage, bone resorption, or delayed healing. Furthermore, conventional thread shapes may not optimize stress distribution during the functional loading phase, potentially contributing to implant failure.

Accordingly, dental implants with improved thread and compression designs for increasing bone fixation and load sharing between a bone/fastener interface experiencing multi-axial and off-loading conditions would be desirable.

### SUMMARY

The various dental implants of the present disclosure have been developed in response to the present state of the art, and in particular, in response to the problems and needs in the art that have not yet been fully solved by currently available dental implants. In some embodiments, the dental implants of the present disclosure may provide improved thread and compression designs for increasing bone fixation and load sharing between a bone/fastener interface experiencing multi-axial and off-loading conditions.

In some embodiments, a threaded dental implant may include a fastener body defining a longitudinal axis. The fastener body may include a proximal end including a threaded socket, a distal end, and a first helical thread disposed about the fastener body along the longitudinal axis. The first helical thread may include a first thread form including a first distal-facing side and a first proximal-facing side, and a second thread form including a second distal-facing side and a second proximal-facing side. The first distal-facing side and the second proximal-facing side may be generally concave. The first proximal-facing side and the second distal-facing side may be generally convex, and the threaded socket may be configured to receive a dental component.

In the threaded dental implant of any preceding paragraph, the fastener body may include a distal portion that is tapered such that a first diameter at the distal end is less than a second diameter at the proximal end.

In the threaded dental implant of any preceding paragraph, the distal portion may include a second helical thread along the longitudinal axis.

In the threaded dental implant of any preceding paragraph, the second helical thread may include a third thread form that is different than the first thread form and the second thread form.

In the threaded dental implant of any preceding paragraph, the third thread form may lack a concave side.

In the threaded dental implant of any preceding paragraph, the first helical thread and the second helical thread may extend along a continuous helical path.

In the threaded dental implant of any preceding paragraph, the first helical thread may include a first thread profile at the distal end and a second thread profile, different than the first thread profile, at the proximal end.

In the threaded dental implant of any preceding paragraph, the proximal end may include a flat proximal surface perpendicular to the longitudinal axis.

In the threaded dental implant of any preceding paragraph, the distal portion may include a second helical thread having a thread form lacking a concave side and the proximal portion may include a third helical thread having a micro-thread form.

In some embodiments, a threaded dental implant may include, a fastener body defining a longitudinal axis, the fastener body including a proximal end including a threaded socket, a distal portion including a tapered portion including a first helical thread along the longitudinal axis, and a second helical thread disposed about the fastener body along the longitudinal axis. The second helical thread may include an even number of thread leads. An odd numbered thread lead may include a first thread form, and an even numbered thread lead may include a second thread form that is different than the first thread form.

In the threaded dental implant of any preceding paragraph, the first helical thread may include a third thread form that is different than the first thread form and the second thread form.

In the threaded dental implant of any preceding paragraph, the third thread form may lack a concave side.

In the threaded dental implant of any preceding paragraph, the first helical thread and the second helical thread may extend along a continuous helical path with a constant pitch.

In the threaded dental implant of any preceding paragraph, the threaded socket may be configured to receive a dental component.

In the threaded dental implant of any preceding paragraph, the proximal portion may include a third helical thread having a micro-thread form.

In some embodiments, a threaded dental implant may include a fastener body defining a longitudinal axis. The fastener body may include a proximal end including a thread socket, a distal end, and a helical thread disposed about the fastener body along the longitudinal axis. The helical thread may include a first thread profile and a second thread profile, and at least one of the first thread profile and the second thread profile may include a concave side.

In the threaded dental implant of any preceding paragraph, the first thread profile may include a dual-lead thread including a first thread form including a concave side and a second thread form including a concave side.

In the threaded dental implant of any preceding paragraph, the second thread profile that may lack a concave side.

In the threaded dental implant of any preceding paragraph, the first thread profile may extend from near the proximal end to the second thread profile and the second thread profile may extend from the first thread profile to near the distal end.

In the threaded dental implant of any preceding paragraph, the fastener body may further include a tapered portion proximate the distal end. The tapered portion may include the second thread profile.

In the threaded dental implant of any preceding paragraph, the first thread profile and the second thread profile may extend along a continuous helical path with a constant pitch.

In the threaded dental implant of any preceding paragraph, the threaded socket may be configured to receive a dental component.

These and other features and advantages of the present disclosure will become more fully apparent from the following description and appended claims or may be learned by the practice of the dental implant devices set forth hereinafter.

### BRIEF DESCRIPTION OF THE DRAWINGS

Exemplary embodiments of the present disclosure will become more fully apparent from the following description taken in conjunction with the accompanying drawings. Understanding that these drawings depict only exemplary embodiments and are, therefore, not to be considered limiting of the scope of the present disclosure, the exemplary embodiments of the present disclosure will be described with additional specificity and detail through use of the accompanying drawings in which:

FIG. 1A is a front perspective view of a fastener according to an embodiment of the present disclosure.

FIG. 1B is a rear perspective view of the fastener body of FIG. 1A.

FIG. 1C is a side view of the fastener body of FIG. 1A.

FIG. 1D is a cross-sectional side view of the fastener body of FIG. 1C, taken along the line A-A.

FIG. 2 is a partial cross-sectional side view of a fastener body according to an embodiment of the present disclosure.

FIG. 3A is a side view of a fastener body according to an embodiment of the present disclosure.

FIG. 3B is a cross-sectional side view of the fastener body of FIG. 3A.

FIG. 3C is a cross-sectional side view of the fastener body of FIG. 3A.

FIG. 4A is a side view of a fastener body according to an embodiment of the present disclosure.

FIG. 4B is a cross-sectional side view of the fastener body of FIG. 4A.

FIG. 5A is a perspective view of a fastener body according to an embodiment of the present disclosure.

FIG. 5B is a side view of the fastener body of FIG. 5A

FIG. 6A is a perspective view of a fastener body according to an embodiment of the present disclosure.

FIG. 6B is a side view of the fastener body of FIG. 6A.

FIG. 7A is a perspective view of an abutment according to an embodiment of the present disclosure.

FIG. 7B is a side view of the abutment of FIG. 7A.

FIG. 8A is a perspective view of an abutment according to an embodiment of the present disclosure.

FIG. 8B is a side view of the abutment of FIG. 8A.

FIG. 9A is a perspective view of a fastener body assembled with an abutment according to an embodiment of the present disclosure.

FIG. 9B is a side view of the fastener body assembled with the abutment of FIG. 9A.

FIG. 10A is a perspective view of a fastener body assembled with a dental crown according to an embodiment of the present disclosure.

FIG. 10B is a side view of the fastener body assembled with the dental crown of FIG. 10A.

It is to be understood that the drawings are for purposes of illustrating the concepts of the present disclosure and may not be drawn to scale. Furthermore, the drawings illustrate exemplary embodiments and do not represent limitations to the scope of the present disclosure.

### DETAILED DESCRIPTION

Exemplary embodiments of the present disclosure will be best understood by reference to the drawings, wherein like parts are designated by like numerals throughout. It will be readily understood that the components of the present disclosure, as generally described and illustrated in the drawings, could be arranged, and designed in a wide variety of different configurations. Thus, the following more detailed description of the embodiments of the devices, systems, and methods, as represented in the drawings, is not intended to limit the scope of the present disclosure but is merely representative of exemplary embodiments of the present disclosure.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in the drawings, the drawings are not necessarily drawn to scale unless specifically indicated.

Standard medical planes of reference and descriptive terminology are employed in this specification. While these terms are commonly used to refer to the human body, certain terms are applicable to physical objects in general.

A standard system of three mutually perpendicular reference planes is employed. A sagittal plane divides a body into right and left portions. A coronal plane divides a body into anterior and posterior portions. A transverse plane divides a body into superior and inferior portions. A mid-sagittal, mid-coronal, or mid-transverse plane divides a body into equal portions, which may be bilaterally symmetric. The intersection of the sagittal and coronal planes defines a superior-inferior or cephalad-caudal axis. The intersection of the sagittal and transverse planes defines an anterior-posterior axis. The intersection of the coronal and transverse planes defines a medial-lateral axis. The superior-inferior or cephalad-caudal axis, the anterior-posterior axis, and the medial-lateral axis are mutually perpendicular.

Anterior means toward the front of a body. Posterior means toward the back of a body. Superior or cephalad means toward the head. Inferior or caudal means toward the feet or tail. Medial means toward the midline of a body, particularly toward a plane of bilateral symmetry of the body. Lateral means away from the midline of a body or away from a plane of bilateral symmetry of the body. Axial means toward a central axis of a body. Abaxial means away from a central axis of a body. Ipsilateral means on the same side of the body. Contralateral means on the opposite side of the body. Proximal means toward the trunk of the body. Proximal may also mean toward a user or operator. Distal means away from the trunk. Distal may also mean away from a user or operator. Dorsal means toward the top of the foot. Plantar means toward the sole of the foot. Varus means deviation of the distal part of the leg below the knee inward, resulting in a bowlegged appearance. Valgus means deviation of the distal part of the leg below the knee outward, resulting in a knock-kneed appearance.

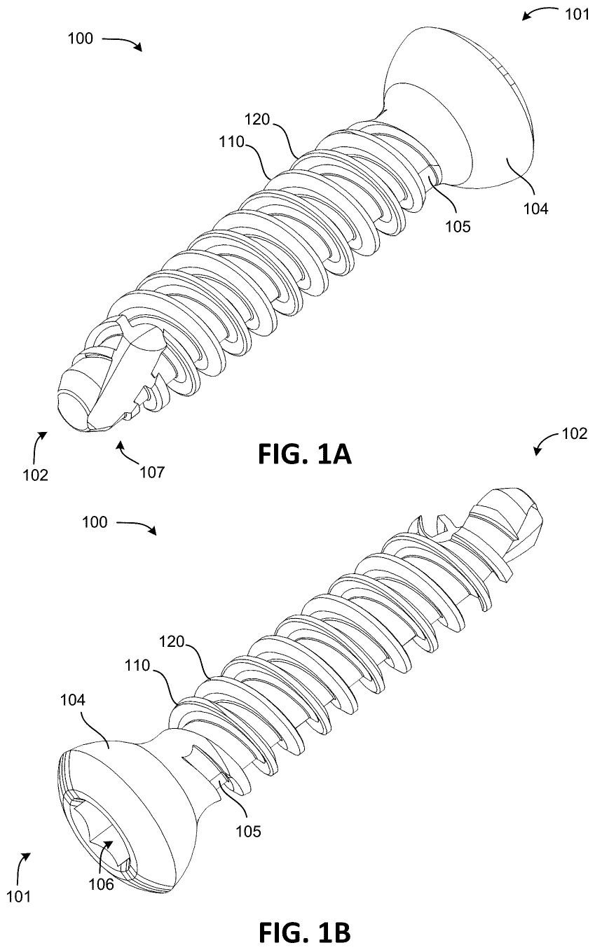

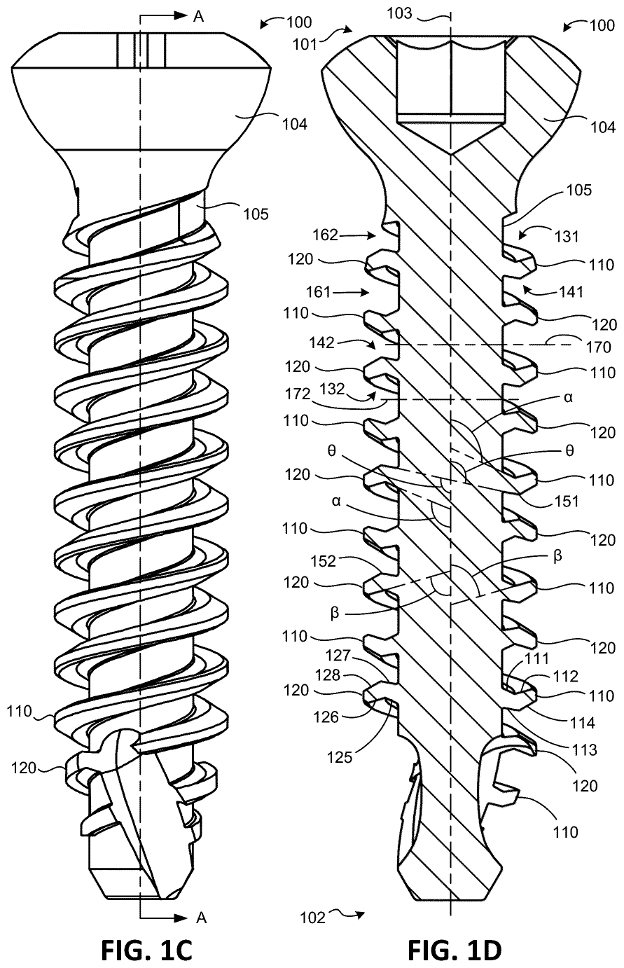

FIGS. 1A-1D are various views of a bone screw, bone implant, implantable bone anchor, bone disunion fastener, and/or fastener 100, according to an example of the present disclosure. Specifically, FIG. 1A is a front perspective view of a fastener 100 according to an embodiment of the present disclosure. FIG. 1B is a rear perspective view of the fastener 100, FIG. 1C is a side view of the fastener 100, and FIG. 1D is a cross-sectional side view of the fastener of FIG. 1C, taken along the line A-A.

Examples of threads oriented with concave sides alternating with as leading and trailing sides may be found in at least U.S. patent application Ser. No. 17/314,028 entitled “FASTENING DEVICES, SYSTEMS, AND METHODS” filed on May 6, 2021 and incorporated herein by reference as though set forth in its entirety.

The fastener 100 may be configured to stabilize disunions between two or more adjacent bones and/or bone portions, such as bone joints, bone fractures, bone abutments, etc. Additionally, or alternatively, the fastener 100 may be configured to secure a second implant (for example: a plate, a rod, a washer, and/or another implant) to a bone.

In general, the fastener 100 may include a shaft 105 having a proximal end 101, a distal end 102, and a longitudinal axis 103. The fastener 100 may also include a head 104 located at the proximal end 101 of the shaft 105, a torque connection interface 106 formed in/on the head 104 (in either a male/female configuration), and a self-tapping feature 107 formed in the distal end 102 of the shaft 105.

The fastener 100 may include a first helical thread 110 disposed about the shaft 105, and a second helical thread 120 disposed about the shaft 105 adjacent the first helical thread 110. The fastener 100 may include a “dual start” or “dual-lead” thread configuration comprising the first helical thread 110 and the second helical thread 120. A depth of the first helical thread 110 and/or the second helical thread 120 with respect to the shaft 105 may define a major diameter vs. a minor diameter of the shaft 105 alone.

In some embodiments, a major diameter and/or a minor diameter of the fastener 100 may be constant or substantially constant along the entire length of the fastener, or along a majority of the length of the fastener 100. In these embodiments, a constant minor diameter may help avoid blowout of narrow/delicate bones (e.g., a pedicle) when inserting the fastener 100 into a bone. A pilot hole may first be drilled into a narrow/delicate bone and then the fastener 100, having a similar minor diameter in comparison to the diameter of the pilot hole, may be chosen to avoid blowout when inserting the fastener 100 into the bone, as will be discussed in more detail below.

Additionally, or alternatively, a depth of the first helical thread 110 and/or the second helical thread 120 with respect to the shaft 105 may vary along a length of the shaft 105 to define one or more major diameters of the fastener 100 and/or one or more regions along the fastener 100 may include one or more continuously variable major diameters.

A thickness of the shaft 105 may vary along a length of the shaft 105 to define one or more minor diameters of the fastener 100, and/or one or more regions along the fastener 100 may include one or more continuously variable minor diameters.

A thickness/height/width/length/pitch/angle/shape, etc., of the first helical thread 110 and/or the second helical thread 120 (or any additional helical thread) may vary along a length of the shaft 105. For example, a thickness/height/width/length/pitch/angle/shape, etc., of the first helical thread 110 and/or the second helical thread 120 may be greater towards the distal end 102 of the fastener 100 and thinner towards the head 104 of the fastener 100 (or vice versa) in either a discrete or continuously variable fashion, etc.

The major diameter and/or minor diameter may increase toward a proximal end 101 or head 104 of a fastener 100 in order to increase bone compaction as the fastener 100 is terminally inserted into the bone/tissue.

A pitch of the first helical thread 110 and/or the second helical thread 120 may vary along a length of the fastener 100. The fastener 100 may include a plurality of helical threads disposed about the shaft 105. However, it will also be understood that any of the fasteners disclosed or contemplated herein may include a single helical thread disposed about the shaft of the fastener. Moreover, the fastener 100 may include a nested plurality of helical threads having different lengths (not shown). As one non-limiting example, the fastener 100 may include a first helical thread 110 that is longer than a second helical thread 120, such that the fastener 100 comprises dual threading along a first portion of the shaft 105 and single threading along a second portion of the shaft 105.

In some embodiments, the plurality of helical threads may include three helical threads comprising a “triple start” or “triple lead” thread configuration (not shown).

In some embodiments, the plurality of helical threads may include four helical threads comprising a “quadruple start” or “quadruple lead” thread configuration (not shown).

In some embodiments, the plurality of helical threads may include more than four helical threads (not shown).

In some embodiments, the fastener 100 may include first threading with any of the shapes disclosed herein oriented toward one of the proximal end 101 and the distal end 102 of the fastener 100, with the first threading located proximate the distal end 102 of the fastener 100, as well as second threading with any of the shapes disclosed herein oriented toward the other one of the proximal end 101 and the distal end 102 of the fastener 100, with the second threading located proximate the head 104 of the fastener 100 (not shown).

The fastener 100 may include multiple threading (e.g., dual helical threading, etc.) with any of the shapes disclosed herein located proximate one of the proximal end 101 and the distal end 102 of the fastener 100, as well as single threading with any of the shapes disclosed herein with the second threading located proximate the other of the proximal end 101 and the distal end 102 of the fastener 100.

The first helical thread 110 may include a plurality of first concave undercut surfaces 131 and a plurality of first convex undercut surfaces 141. The second helical thread 120 may include a plurality of second concave undercut surfaces 132 and a plurality of second convex undercut surfaces 142.

In some embodiments, when the fastener 100 is viewed in section along a plane that intersects the longitudinal axis 103 of the shaft 105 (e.g., see FIG. 1D), the plurality of first concave undercut surfaces 131 and the plurality of second convex undercut surfaces 142 may be oriented toward (i.e., point toward) the proximal end 101 of the fastener 100. Additionally, the plurality of first convex undercut surfaces 141 and the plurality of second concave undercut surfaces 132 may be oriented toward (i.e., point toward) the distal end 102 of the fastener 100.

In some embodiments, at least one of the plurality of first concave undercut surfaces 131, the plurality of first convex undercut surfaces 141, the plurality of second concave undercut surfaces 132, and the plurality of second convex undercut surfaces 142 may comprise at least one substantially flat surface.

When the fastener 100 is viewed in section along a plane intersecting the longitudinal axis 103 of the shaft 105, the first helical thread 110 may include a plurality of first bent shapes (comprising at least one surface that is angled relative to the longitudinal axis 103 of the shaft 105 and/or at least one undercut surface) with a plurality of first intermediate portions 151 that are oriented toward (i.e., point toward) the distal end 102 of the fastener 100. This may be referred to as “conventional” threading, or having a “conventional” orientation.

When the fastener 100 is viewed in section along a plane intersecting the longitudinal axis 103 of the shaft 105, the second helical thread 120 may comprise a plurality of second bent shapes (comprising at least one surface that is angled relative to the longitudinal axis 103 of the shaft 105 and/or at least one undercut surface) with a plurality of second intermediate portions 152 that are oriented toward (i.e., point toward) the proximal end 101 of the fastener 100. This may be referred to as “inverted” threading, or having an “inverted” orientation, or an “undercut thread”.

In some embodiments, one or more helical threads may morph/transition between a conventional orientation and an inverted orientation along a shaft of a fastener 100.

In some embodiments, at least one of the plurality of first concave undercut surfaces 131, the plurality of first convex undercut surfaces 141, the plurality of second concave undercut surfaces 132, and the plurality of second convex undercut surfaces 142 may include at least one curved surface.

As shown in FIG. 1D, the proximally-oriented and distally-oriented surfaces of the first helical thread 110 (i.e., the first concave undercut surfaces 131 and the first convex undercut surfaces 141 in the fastener 100 of FIG. 1D) may not have mirror symmetry relative to each other about any plane perpendicular to the longitudinal axis 103 of the fastener 100. Rather, the first concave undercut surfaces 131 may be offset from the first convex undercut surfaces 141.

The same may be true for the second helical thread 120, in which the second concave undercut surfaces 132 and the second convex undercut surfaces 142 may not have mirror symmetry relative to each other about any plane perpendicular to the longitudinal axis 103 of the fastener 100.

Conversely, as also shown in FIG. 1D, the proximally-oriented surfaces of the first helical thread 110 may have mirror symmetry relative to the distally-oriented surfaces of the second helical thread 120. Specifically, the first concave undercut surfaces 131 may have mirror symmetry relative to the second convex undercut surfaces 142 about a plane 170 that bisects the space between them and lies perpendicular to the longitudinal axis 103.

Similarly, the distally-oriented surfaces of the first helical thread 110 may have mirror symmetry relative to the proximally-oriented surfaces of the second helical thread 120. Specifically, the second concave undercut surfaces 132 may have mirror symmetry relative to the first convex undercut surfaces 141 about a plane 172 that bisects the space between them and lies perpendicular to the longitudinal axis 103.

This mirror symmetry may be present along most of the length of the first helical thread 110 and the second helical thread 120, with symmetry across different planes arranged between adjacent turns of the first helical thread 110 and the second helical thread 120 along the length of the longitudinal axis 103. Such mirror symmetry may help more effectively capture bone between the first helical thread 110 and the second helical thread 120 and may also facilitate manufacture of the fastener 100.

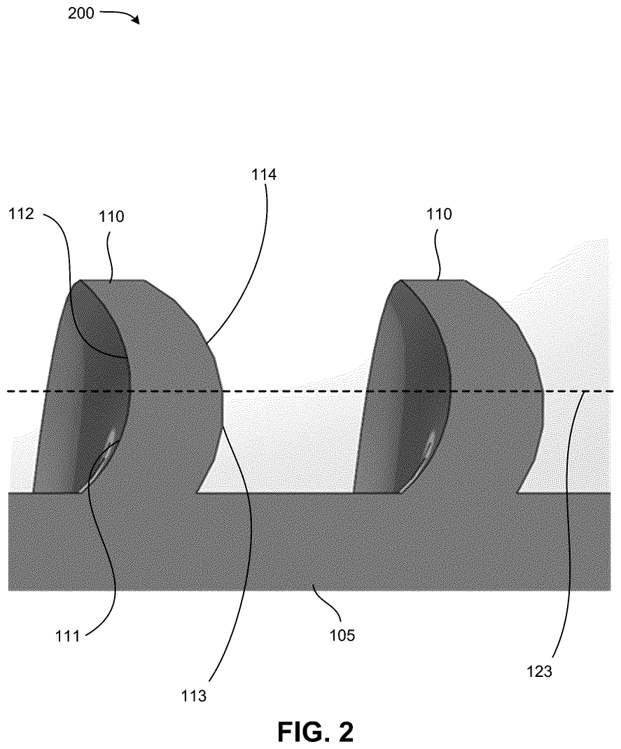

In some embodiments, when the fastener 100 is viewed in section along a plane intersecting the longitudinal axis 103 of the shaft 105, the first helical thread 110 may include at least one partial crescent shape that is oriented toward (i.e., points toward) the distal end 102 of the shaft 105 and/or the proximal end 101 of the shaft 105. FIG. 2 illustrates a partial cross-sectional view of a fastener 200 comprising crescent shapes, as one non-limiting example of such an embodiment.

In some embodiments (not shown), when the fastener 100 is viewed in section along a plane intersecting the longitudinal axis 103 of the shaft 105, the first helical thread 110 may include at least one partial crescent shape that is oriented toward (i.e., points toward) the distal end 102 of the shaft 105, and the second helical thread 120 may include at least one partial crescent shape that is oriented toward (i.e., points toward) the proximal end 101 of the shaft 105.

In some embodiments (not shown), the first helical thread 110 may include a first plurality of partial crescent shapes that are oriented toward (i.e., point toward) the distal end 102 of the shaft 105, and the second helical thread 120 may include a second plurality of partial crescent shapes that are oriented toward (i.e., point toward) the proximal end 101 of the shaft 105.

In some embodiments (not shown), the first plurality of partial crescent shapes and the second plurality of partial crescent shapes may be arranged in alternating succession along the shaft 105 of the fastener 100.

In some embodiments, the first helical thread 110 may be bisected by the line 123 shown in FIG. 2 with each crescent shape including a plurality of first undercut surfaces 111, a plurality of second undercut surfaces 112, a plurality of third undercut surfaces 113, and a plurality of fourth open surfaces 114 similar to the helical threading shown in FIG. 1D, except with curved surfaces in place of flat surfaces.

The plurality of first undercut surfaces 111 and the plurality of second undercut surfaces 112 may comprise concave curved surfaces. However, it will be understood that portions of the plurality of first undercut surfaces 111 and/or portions of the plurality of second undercut surfaces 112 may also comprise convex curved surfaces and/or flat surfaces (not shown in FIG. 2).

The plurality of third undercut surfaces 113 and the plurality of fourth open surfaces 114 may comprise convex curved surfaces. However, it will be understood that portions of the plurality of third undercut surfaces 113 and the plurality of fourth open surfaces 114 may also comprise concave curved surfaces and/or flat surfaces (not shown in FIG. 2).

The plurality of third undercut surfaces 113 and the plurality of fourth open surfaces 114 may be replaced by a ramped surface (such as that utilized in a conventional buttress thread design) without any undercuts (not shown in FIG. 2). Likewise, any of the other thread designs disclosed herein may utilize a ramped or buttress thread design on at least one side of the helical thread.

In some embodiments, a fastener may have only conventional threads or only undercut threads, for example, a thread lacking a concave side. The type of threads that are desired may depend on the type and/or magnitude of loads to be applied to the fastener. For example, a screw loaded axially away from the bone in which it is implanted may advantageously have a conventional thread, while a screw loaded axially toward the bone in which it is implanted may advantageously have an undercut thread. A screw that may experience multi-axial loading and/or off-loading conditions may advantageously include at least one conventional thread (lacking a concave side) and at least one undercut thread in order to increase bone fixation and load sharing between a bone/fastener interface during multi-axial and off-loading conditions to reduce high bone strain and distribute multi-axial forces applied to the bone in a load-sharing, rather than load-bearing, configuration. Shear loads and/or bending moments may also be optimally resisted with any chosen combination of threading, threading morphology, and/or threading variations contemplated herein to optimally resist shear loads, bending moments, multi-axial loading, off-loading conditions, etc.

In some embodiments, fasteners with conventional threads may be used in conjunction with fasteners with undercut threads in order to accommodate different loading patterns.

In some embodiments, a single fastener may have both conventional and undercut threads, like the fastener 100. Such a combination of threads may help the fastener 100 remain in place with unknown and/or varying loading patterns.

In some embodiments, the geometry of the threading of a fastener (with conventional and/or undercut threads) may be varied to suit the fastener for a particular loading scheme. For example, the number of threads, the number of thread starts (or thread leads), the pitch of the threading, the shape(s) of the threading, any dimension(s) associated with the threading (e.g., any length(s)/width(s)/height(s)/inflection point(s), etc., associated with the threading), the major diameter(s), the minor diameter(s), the pitch diameter(s), any angulation/angles associated with any surfaces of the threading, the “handedness” of the threading (e.g., right-handed vs. left-handed), etc., may be varied accordingly to suit any specific medium of installation, loading pattern, desired radial loading force, pull-out strength, application, procedure, etc., that may be involved.

The material(s) of any portion of a bone implant, joint replacement implant, fastener, bone disunion fastener, etc., described herein may include, but are not limited to: metals (e.g., titanium, cobalt, etc.), metal alloys (stainless steel, titanium alloy, nickel-titanium alloy, etc.), plastics, polymers, ceramics, PEEK, UHMWPE, composites, additive particles, textured surfaces, biologics, biomaterials, bone, etc.

Any of the fasteners or implants described herein may include additional features such as: self-tapping features, cutting flutes, locking features (e.g., locking threading formed on a portion of the fastener, such as threading located on or near a head of the fastener), opening(s), cannulation(s), fenestration(s), any style of fastener head (or no fastener head at all), any style of torque connection interface (or no torque connection interface at all), etc.

The opening(s), cannulation(s), fenestration(s), etc., formed in any of the fasteners or implants described herein may be configured to receive any suitable bone cement or bone augment material therein to facilitate bone in-growth, bone fusion, etc.

In some embodiments, a tap (not shown) may be utilized to pre-form threading in a bone or bone augment material according to any threading shape that is disclosed or contemplated herein. In this manner, taps with any suitable shape may be utilized in conjunction with any fastener described or contemplated herein to match or substantially match the threading geometry of a given fastener or bone implant.

A minor diameter of the fastener may be selected to match, or substantially match, a diameter of a pilot hole that is formed in a bone to avoid bone blowout when the fastener is inserted into the pilot hole.

Additionally, or alternatively thereto, the type of threads and/or thread geometry may be varied based on the type of bone in which the fastener is to be anchored. For example, fasteners anchored in osteoporotic bone may fare better with conventional or undercut threads, or when the pitch, major diameter, and/or minor diameter are increased or decreased, or when the angulation of thread surfaces is adjusted, etc.

The fastener 100 may be one of a set of fasteners each having a different thread option described or contemplated herein. A surgical kit may include multiple fasteners/implants with any of the different fasteners/implants and thread options described or contemplated herein. A surgeon may select the appropriate fasteners/implants from the kit based on the particular loads to be applied and/or the quality of bone in which the fastener/implants are to be anchored.

Continuing with FIG. 1D, the first helical thread 110 may include a plurality of first undercut surfaces 111, a plurality of second undercut surfaces 112, a plurality of third undercut surfaces 113, and a plurality of fourth open surfaces 114.

The second helical thread 120 may include a plurality of fifth undercut surfaces 125, a plurality of sixth undercut surfaces 126, a plurality of seventh undercut surfaces 127, and a plurality of eighth open surfaces 128.

One or more of the plurality of first undercut surfaces 111, the plurality of second undercut surfaces 112, the plurality of third undercut surfaces 113, the plurality of fourth open surfaces 114, the plurality of fifth undercut surfaces 125, the plurality of sixth undercut surfaces 126, the plurality of seventh undercut surfaces 127, and the plurality of eighth open surfaces 128 may include at least one flat or substantially flat surface.

The plurality of first undercut surfaces 111, the plurality of third undercut surfaces 113, the plurality of sixth undercut surfaces 126, and the plurality of eighth open surfaces 128 may be angled towards the distal end 102 of the shaft 105.

The plurality of second undercut surfaces 112, the plurality of fourth open surfaces 114, the plurality of fifth undercut surfaces 125, and the plurality of seventh undercut surfaces 127 may be angled towards the proximal end 101 of the shaft 105.

In some embodiments, when the fastener 100 is viewed in section along a plane that intersects the longitudinal axis 103 of the shaft 105 (as shown in FIG. 1D), the first helical thread 110 may include at least one chevron shape that is oriented toward (i.e., points toward) the distal end 102 of the shaft 105. Likewise, the second helical thread 120 may also include at least one chevron shape that is oriented toward (i.e., points toward) the proximal end 101 of the shaft 105.

When the fastener 100 is viewed in section along a plane that intersects the longitudinal axis 103 of the shaft 105 (as shown in FIG. 1D), the first helical thread 110 may include a first plurality of chevron shapes that are oriented toward (i.e., point toward) the distal end 102 of the shaft 105. Likewise, the second helical thread 120 may include a second plurality of chevron shapes that are oriented toward (i.e., point toward) the proximal end 101 of the shaft 105.

The first plurality of chevron shapes and the second plurality of chevron shapes may be arranged in alternating succession along the shaft 105 of the fastener 100, (e.g., see FIG. 1D).

A plurality of first interlocking spaces 161 and a plurality of second interlocking spaces 162 may be formed between the first helical thread 110 and the second helical thread 120 along the shaft 105 of the fastener 100. The plurality of first interlocking spaces 161 may be formed intermediate the first concave undercut surfaces 131 and the second concave undercut surfaces 132. The plurality of second interlocking spaces 162 may be formed intermediate the first convex undercut surfaces 141 and the second convex undercut surfaces 142. The plurality of first interlocking spaces 161 may be larger in size than the plurality of second interlocking spaces.

The plurality of first interlocking spaces 161 and the plurality of second interlocking spaces 162 may be shaped and/or configured to interlock with bone/other tissues received therein to increase fixation of the fastener 100 within the bone/other tissues and provide additional resistance against multi-axial forces that may be applied to the fastener 100 and/or the bone/other tissues.

The plurality of second undercut surfaces 112 and the plurality of sixth undercut surfaces 126 may be angled toward each other to trap bone/bone augment material within the plurality of first interlocking spaces 161 in order to increase fixation and resistance against multi-axial forces. The plurality of third undercut surfaces 113 and the plurality of seventh undercut surfaces 127 may be angled toward each other to trap bone/other tissues within the plurality of second interlocking spaces 162 in order to increase fixation and resistance against multi-axial forces.

The plurality of first undercut surfaces 111 and the plurality of fifth undercut surfaces 125 may each form an angle α with respect to the longitudinal axis 103 of the shaft 105, as shown in FIG. 1D. The angle α may be greater than 90 degrees.

The plurality of second undercut surfaces 112 and the plurality of sixth undercut surfaces 126 may each form an angle β with respect to the longitudinal axis 103 of the shaft 105. The angle β may be less than 90 degrees.

The plurality of third undercut surfaces 113 and the plurality of seventh undercut surfaces 127 may each form an angle θ with respect to the longitudinal axis 103 of the shaft 105. The angle θ may be approximately 90 degrees. Alternatively, the angle θ may be greater than 90 degrees.

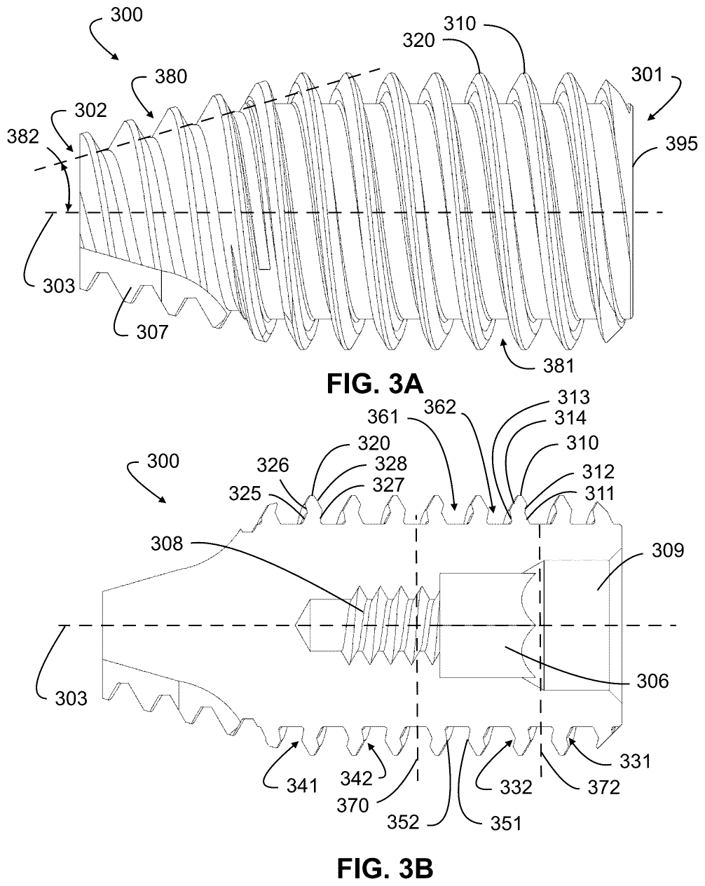

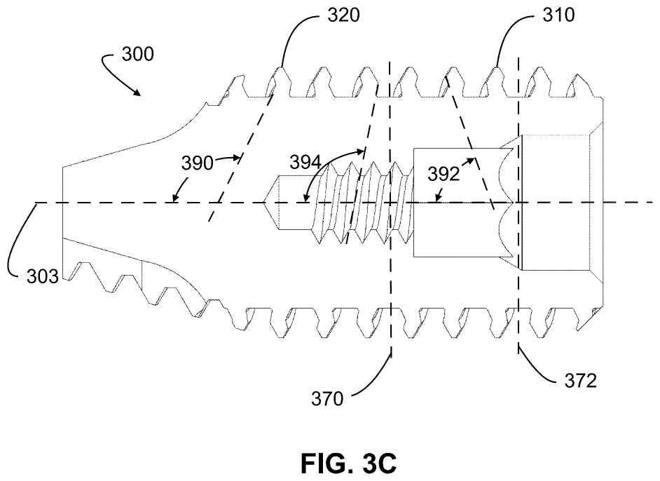

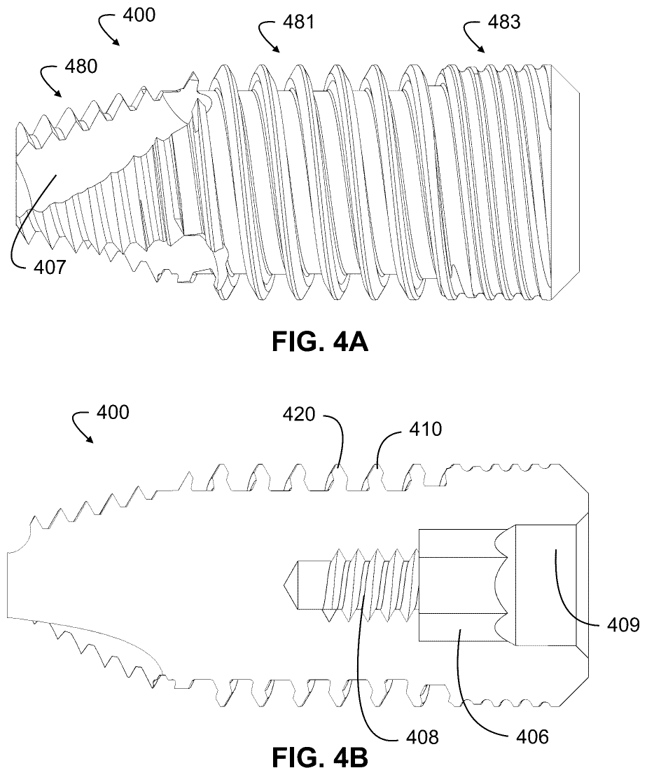

FIG. 3A is a side view of a fastener body 300 according to an embodiment of the present disclosure. FIG. 3B is a cross-sectional side view of the fastener body 300 and FIG. 3C is a cross-sectional side view of the fastener body 300. The fastener body 300 may be configured as a threaded dental implant. The fastener body 300 may be further configured to be secured to a bone and to receive a dental component, such as an abutment 1300, an abutment 1400, and/or a dental crown 1500 (as shown in FIG. 4A through FIG. 7B). The fastener body 300 may be threadably advanced into the bone after a pilot hole is created. The pilot hole may be sized to be generally equal to a minor thread diameter of the fastener body 300, thereby limiting undue compression and damage to the bone as well as reducing insertion torque.

The fastener body 300 may include a body portion 381 having a longitudinal axis 303, a proximal end 301, and a distal end 302. The fastener body 300 may further include a first helical thread disposed about the body portion 381 along the longitudinal axis 303. The first helical thread may be configured as a dual-lead thread and may include a first thread form 310 and a second thread form 320. A depth of the first helical thread with respect to the body portion 381 may define a major diameter and a minor diameter of the first helical thread.

The major diameter and/or the minor diameter of the first helical thread may be constant or substantially constant along the entire length of the fastener, or along a majority of the length of the fastener body 300. A constant minor diameter may help avoid blowout of narrow/delicate bones when inserting the fastener body 300 into the bone.

Alternatively, the first thread form may include an even number of thread leads, for example: a dual-lead thread, a four-lead thread, etc. Each of the odd numbered thread leads may include a thread form that is generally the same as the first thread form 310. Additionally, each of the even numbered thread leads may include a thread form that is generally the same as the second thread form 320.

The fastener body 300 may include first threading with any of the shapes disclosed herein oriented toward one of the proximal end 301 and the distal end 302 of the fastener body 300, with the first threading located proximate the distal end 302 of the fastener body 300, as well as second threading with any of the shapes disclosed herein oriented toward the other one of the proximal end 301 and the distal end 302 of the fastener body 300.

The first helical thread may extend from the proximal end 301 to the distal end 302. Alternatively, the first helical thread may extend from near the proximal end 301 to the near distal end 302. The fastener body 300 may lack a head or any portion that has a diameter greater than a major thread diameter of the first helical portion.

Additionally, or alternatively, the fastener body 300 may include a distal portion 380 proximate the distal end 302. The distal portion 380 may be a tapered portion such that a first diameter at the distal end 302 is less than a second diameter at the proximal end 301. A taper angle 382 may be measured between the longitudinal axis 303 and an axis parallel to the distal portion 380. The taper angle 382 may be between 5 degrees and 45 degrees. More specifically, the taper angle may be between 15 degrees and 35 degrees.

The distal portion 380 may include a second helical thread disposed about the distal portion 380 along the longitudinal axis 303. Alternatively, the distal portion 380 may be absent any threads.

The second helical thread may include a third thread form that is different than the first thread form and the second thread form. Additionally, or alternatively, the second helical thread may be configured as a dual-lead thread and may include a fourth thread form that is different than the first thread form and the second thread form.

Additionally, or alternatively the second helical thread may include a conventional thread form, (for example: a ‘V’ thread form, a buttress thread form, an acme thread form, a square thread form, a knuckle thread form, etc.). Additionally, or alternatively, the second helical thread may include a multi-lead conventional thread form. As defined herein, a conventional thread and/or a standard thread may include a thread form lacking an undercut and/or a concave side.

The first helical thread and the second helical thread may extend along a continuous helical path. The first helical thread and the second helical thread may have the same pitch. The first helical thread and the second helical thread may have a constant pitch. Additionally, or alternatively, the first helical thread and/or the second helical thread may have a variable thread pitch while maintaining a smooth transition from the first helical thread to the second helical thread.

The first helical thread may extend from the proximal end 301 to the second helical thread. The second helical thread may extend from the first helical thread to the distal end. Alternatively, the first helical thread may extend from near the proximal end 301 to the second helical thread. The second helical thread may extend from the first helical thread to near the distal end.

The first helical thread may include a first thread profile proximate the proximal end 301 and a second thread profile proximate the distal end 302. For example, the first thread profile may include the first thread form 310 and/or the second thread form 320 while the second thread profile may include a conventional thread form. Alternatively, the first thread profile and the second thread profile may each include any thread form described herein and/or a conventional thread form. Additionally, or alternatively, the first thread profile may gradually morph into the second thread profile along the first helical thread while maintaining a continuous helical path.

Additionally, or alternatively, one of the first helical thread and the second helical thread may be a single lead thread having a pitch, p. For a single lead thread, one rotation of the fastener advances the fastener by a distance equal to the pitch, p. The other of the first helical thread and the second helical thread may have a dual-lead thread having a lead length, L. For a dual-lead thread, one rotation of the fastener advances the fastener by a distance equal to the lead length, L. The fastener body 300 may include the first helical thread and the second helical thread, whereby L=2p so that the fastener body 300 advances the same distance per rotation of the fastener body 300 relative to the bone when either the first helical thread or the second helical thread is engaged with the bone.

The fastener body 300 may further include a torque connection interface 306 formed in/on the proximal end 301 (in either a male/female configuration), and a cutting flute 307 formed in the distal end 302 of the fastener body 300. The proximal end 301 may further include a flat proximal surface 395 that may be perpendicular to the longitudinal axis 303.

The proximal surface may include a torque connection interface 306, a threaded socket 308, and an internal pocket 309. The torque connection interface 306 may be configured to receive a driver (not shown) configured to transfer torque to the fastener body 300 in order to drive the fastener into the bone. The internal pocket 309 and the threaded socket 308 may be configured to receive a dental component so that the dental component is secured to the fastener body 300, thereby securing the dental component relative to the bone.

The first thread form 310 may include a plurality of first concave undercut surfaces on a first proximal-facing side 331 and a plurality of first convex undercut surfaces on a first distal-facing side 341. The second thread form 320 may include a plurality of second concave undercut surfaces on a second distal-facing side 332 and a plurality of second convex undercut surfaces on a second proximal-facing side 342.

As shown in FIGS. 3A & 3B, the first proximal-facing side 331 and the second proximal-facing side 342 may be oriented toward (i.e., point toward) the proximal end 301 of the fastener body 300. Additionally, the first distal-facing side 341 and the second distal-facing side 332 may be oriented toward (i.e., point toward) the distal end 302 of the fastener body 300.

At least one of the first proximal-facing side 331, the first distal-facing side 341, the second distal-facing side 332, and the second proximal-facing side 342 may comprise at least one substantially flat surface.

the first thread form 310 may include a plurality of first bent shapes (comprising at least one surface that is angled relative to the longitudinal axis 303 and/or at least one undercut surface) with a plurality of first intermediate portions 351 that are oriented toward (i.e., point toward) the distal end 302 of the fastener body 300.

The second thread form 320 may comprise a plurality of second bent shapes (comprising at least one surface that is angled relative to the longitudinal axis 303 and/or at least one undercut surface) with a plurality of second intermediate portions 352 that are oriented toward (i.e., point toward) the proximal end 301 of the fastener body 300.

In some embodiments, at least one of the first proximal-facing side 331, the first distal-facing side 341, the second distal-facing side 332, and the second proximal-facing side 342 may include at least one curved surface.

The proximally-oriented and distally-oriented surfaces of the first thread form 310 (i.e., the first proximal-facing side 331 and the first distal-facing side 341) may not have mirror symmetry relative to each other about any plane perpendicular to the longitudinal axis 303. Rather, the first proximal-facing side 331 may be offset from the first distal-facing side 341.

The same may be true for the second thread form 320, in which the second distal-facing side 332 and the second proximal-facing side 342 may not have mirror symmetry relative to each other about any plane perpendicular to the longitudinal axis 303.

The proximally-oriented surfaces of the first thread form 310 may have mirror symmetry relative to the distally-oriented surfaces of the second thread form 320. Specifically, the first proximal-facing side 331 may have mirror symmetry relative to the second proximal-facing side 342 about a plane 370 that bisects the space between them and lies perpendicular to the longitudinal axis 303.

Similarly, the distally-oriented surfaces of the first thread form 310 may have mirror symmetry relative to the proximally-oriented surfaces of the second thread form 320. Specifically, the second distal-facing side 332 may have mirror symmetry relative to the first distal-facing side 341 about a plane 372 that bisects the space between them and lies perpendicular to the longitudinal axis 303.

This mirror symmetry may be present along most of the length of the first thread form 310 and the second thread form 320, with symmetry across different planes arranged between adjacent turns of the first thread form 310 and the second thread form 320 along the length of the longitudinal axis 303. Such mirror symmetry may help more effectively capture bone between the first thread form 310 and the second thread form 320 and may also facilitate manufacture of the fastener body 300.

The first thread form 310 and the second thread form 320 may be configured as undercut threads. The first thread form 310 may include a plurality of first undercut surfaces 311, a plurality of second undercut surfaces 312, a plurality of third undercut surfaces 313, and a plurality of fourth open surfaces 314. The second thread form 320 may include a plurality of fifth undercut surfaces 325, a plurality of sixth undercut surfaces 326, a plurality of seventh undercut surfaces 327, and a plurality of eighth open surfaces 328. Undercut threads may differ from conventional threads, as conventional threads lack any undercut surfaces.

The fastener body 300 may have conventional threads and/or undercut threads. The type of threads that are desired may depend on the type and/or magnitude of loads to be applied to the fastener body 300. A screw that may experience multi-axial loading and/or off-loading conditions may advantageously include at least one undercut thread in order to increase bone fixation and load sharing between a bone/fastener interface during multi-axial and off-loading conditions to reduce high bone strain and distribute multi-axial forces applied to the bone in a load-sharing, rather than load-bearing, configuration. Shear loads and/or bending moments may also be optimally resisted with any chosen combination of threading, threading morphology, and/or threading variations contemplated herein to optimally resist shear loads, bending moments, multi-axial loading, off-loading conditions, etc.

The geometry of the threading of the fastener body 300 may be varied to suit the fastener body 300 for a particular loading scheme. For example, the number of threads, the number of thread starts (or thread leads), the pitch of the threading, the shape(s) of the threading, any dimension(s) with associated the threading (e.g., any length(s)/width(s)/height(s)/inflection point(s), etc., associated with the threading), the major diameter(s), the minor diameter(s), the pitch diameter(s), any angulation/angles associated with any surfaces of the threading, the “handedness” of the threading (e.g., right-handed vs. left-handed), etc., may be varied accordingly to suit any specific medium of installation, loading pattern, desired radial loading force, pull-out strength, application, procedure, etc., that may be involved.

A plurality of first interlocking spaces 361 and a plurality of second interlocking spaces 362 may be formed between the first thread form 310 and the second thread form 320 along the fastener body 300. The plurality of first interlocking spaces 361 may be formed intermediate the first proximal-facing side 331 and the second distal-facing side 332. The plurality of second interlocking spaces 362 may be formed intermediate the first distal-facing side 341 and the second proximal-facing side 342. The plurality of first interlocking spaces 361 may be larger in size than the plurality of second interlocking spaces 362.

The plurality of first interlocking spaces 361 and the plurality of second interlocking spaces 362 may be shaped and/or configured to interlock with bone/other tissues received therein to increase fixation of the fastener body 300 within the bone/other tissues and provide additional resistance against multi-axial forces that may be applied to the fastener body 300 and/or the bone/other tissues.

The plurality of second undercut surfaces 312 and the plurality of sixth undercut surfaces 326 may be angled toward each other to trap bone/bone augment material within the plurality of first interlocking spaces 361 in order to increase fixation and resistance against multi-axial forces. The plurality of third undercut surfaces 313 and the plurality of seventh undercut surfaces 327 may be angled toward each other to trap bone/other tissues within the plurality of second interlocking spaces 362 in order to increase fixation and resistance against multi-axial forces.

The plurality of first undercut surfaces 311 and the plurality of fifth undercut surfaces 325 may each form an angle 390 with respect to the longitudinal axis 103. The angle 390 may be greater than 90 degrees.

The plurality of second undercut surfaces 312 and the plurality of sixth undercut surfaces 326 may each form an angle 392 with respect to the longitudinal axis 303. The angle 392 may be less than 90 degrees.

The plurality of third undercut surfaces 313 and the plurality of seventh undercut surfaces 327 may each form an angle 394 with respect to the longitudinal axis 103. The angle 394 may be approximately 90 degrees. Alternatively, the angle 394 may be greater than 90 degrees.

Due to the undercut surfaces, the first thread form 310 and the second thread form 320 may not be manufacturable using standard machining methods. The first thread form 310 and the second thread form 320 may be machined using any of the methods described in U.S. Provisional Patent Application Ser. No. 63/569,174 herein incorporated by reference in its entirety.

FIG. 4A is a side view of a fastener body 400 according to an embodiment of the present disclosure. FIG. 4B is a cross-sectional side view of the fastener body 400. The fastener body 400 may be configured as a threaded dental implant. The fastener body 400 may be further configured to be secured to a bone and to receive a dental component.

Various parts of the fastener body 400 may be identical or similar to their counterparts on the fastener body 300 presented herein; these parts may not be described again here. All statements made regarding the fastener body 300 may apply to the fastener body 400 unless they would be contradicted by the differences between the two.

The fastener body 400 may include a distal portion 480, a proximal portion 483, and a body portion 481 between the distal portion 480 and the proximal portion 483. The body portion 481 may include a first helical thread that may be configured as a dual-lead thread including a first thread form 410 and a second thread form 420. The first thread form 410 may include the same features as the first thread form 310 previously described. The second thread for 420 may include the same features as the second thread form 320 previously described.

The proximal portion 483 may include a third thread form 415. The third thread form 415 may be configured as a micro-thread form. Additionally, or alternatively, the third thread form 415 may lack an undercut and/or a concave side.

The distal portion 480 may include a tapered lead-in. the tapered lead-in may include a fourth thread form 416. The fourth thread form 416 may be configured as a conventional thread form. Additionally, or alternatively, the fourth thread form 416 may lack an undercut and/or a concave side.

The fastener body 400 may further include an internal pocket 409, a threaded socket 408, a torque connection feature 406, and a cutting flute 407. The torque connection interface 406 may be configured to receive a driver (not shown) configured to transfer torque to the fastener body 400 in order to drive the fastener into the bone. The internal pocket 409 and the threaded socket 408 may be configured to receive a dental component so that the dental component is secured to the fastener body 400, thereby securing the dental component relative to the bone.

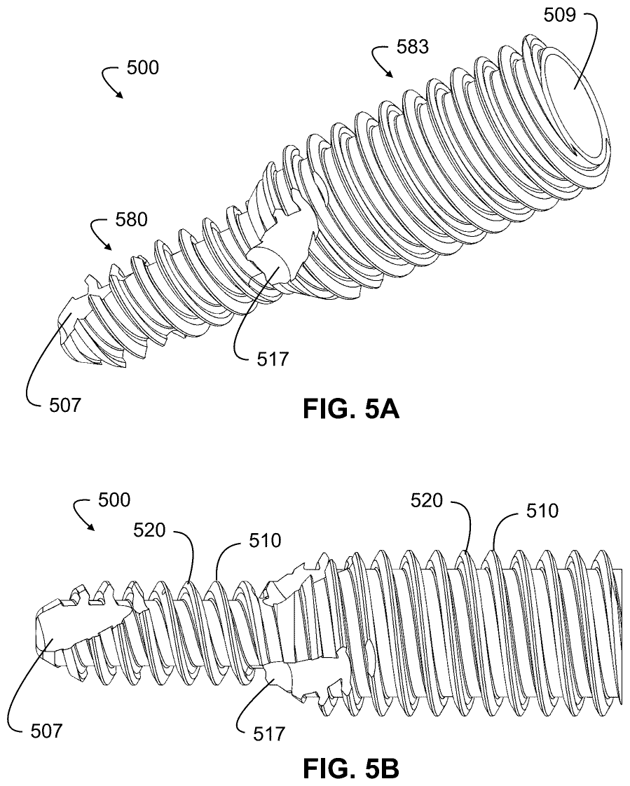

FIG. 5A is a perspective view of a fastener body 500 according to an embodiment of the present disclosure. FIG. 5B is a side view of the fastener body 500. The fastener body 500 may be configured as a threaded dental implant. The fastener body 500 may be further configured to be secured to a bone and to receive a dental component.

Various parts of the fastener body 500 may be identical or similar to their counterparts on the fastener body 300 presented herein; these parts may not be described again here. All statements made regarding the fastener body 300 may apply to the fastener body 500 unless they would be contradicted by the differences between the two.

The fastener body 500 may include a first helical thread 580 having a generally constant first major diameter and a correspondingly generally constant first minor diameter. The fastener body 500 may further include a second helical thread 583 having a generally constant second major diameter and a correspondingly generally constant second minor diameter. The second major diameter may be greater than the first major diameter. The second minor diameter may be greater than the first minor diameter.

The first helical thread 580 and the second helical thread 583 may be configured as a dual lead thread including a first thread form 510 and a second thread form 520 each including an undercut and/or a concave side. The first thread form 510 may include the same features as the first thread form 310 previously described. The second thread for 520 may include the same features as the second thread form 320 previously described.

The first helical thread 580 may extend from a distal end. The distal end may, or may not, include one or more first self-tapping flutes and/or cutting flutes. The second helical thread 583 may extend from a proximal end.

The fastener body 500 may further include a first cutting flute 507 formed in the distal end. A transition taper between the first major diameter and the second major diameter may, or may not, include a second cutting flute 517.

The fastener body 500 may further include an internal pocket 509 configured to receive a dental component so that the dental component is secured to the fastener body 500, thereby securing the dental component relative to the bone.

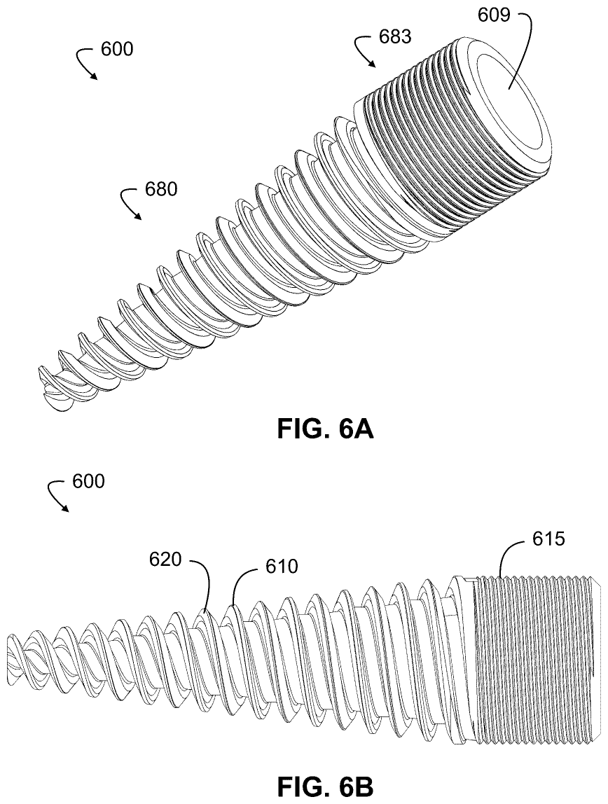

FIG. 6A is a perspective view of a fastener body 600 according to an embodiment of the present disclosure. FIG. 6B is a side view of the fastener body 600. The fastener body 600 may be configured as a threaded dental implant. The fastener body 600 may be further configured to be secured to a bone and to receive a dental component.

Various parts of the fastener body 600 may be identical or similar to their counterparts on the fastener body 300 presented herein; these parts may not be described again here. All statements made regarding the fastener body 300 may apply to the fastener body 600 unless they would be contradicted by the differences between the two.

The fastener body 600 may include a distal portion 680 and a proximal portion 683. The distal portion 480 may include a first helical thread that may be configured as a dual-lead thread including a first thread form 610 and a second thread form 620. The first thread form 610 may include the same features as the first thread form 310 previously described. The second thread for 620 may include the same features as the second thread form 320 previously described.

The proximal portion 683 may include a second thread form 615. The second thread form 615 may be configured as a micro-thread form. Additionally, or alternatively, the second thread form 615 may lack an undercut and/or a concave side.

The distal portion 680 may be generally tapered from a distal end to the proximal portion 683.

The fastener body 600 may further include an internal pocket 609. The internal pocket 609 may be configured to receive a dental component so that the dental component is secured to the fastener body 600, thereby securing the dental component relative to the bone.

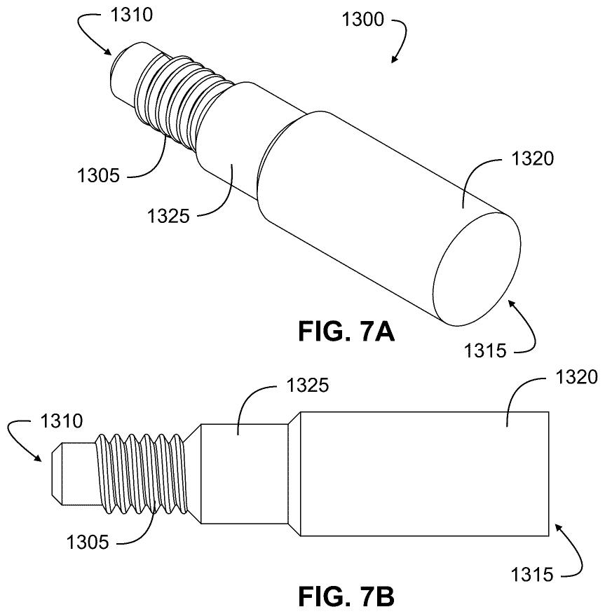

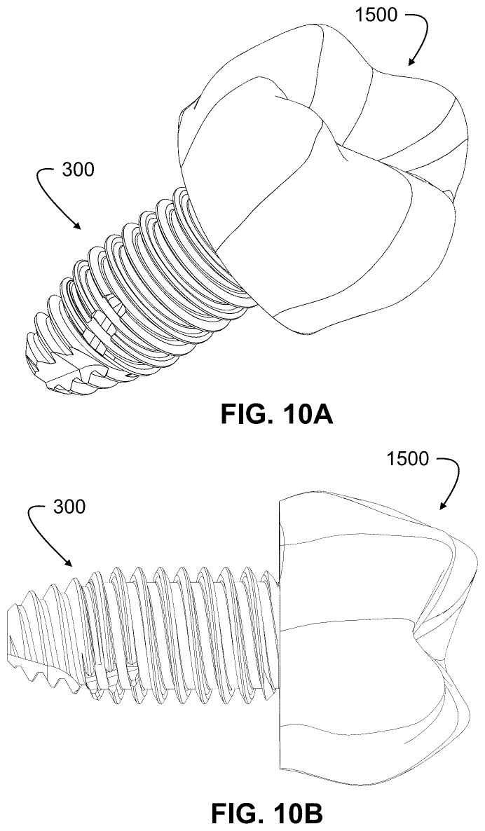

FIG. 7A is a perspective view of an abutment 1300 according to an embodiment of the present disclosure. FIG. 7B is a side view of the abutment 1300. The abutment 1300 may be configured to be received in a fastener body 300 and provide a post and/or anchor point for a dental crown 1500 (as shown in FIGS. 10A & 10B), a dental bridge, and/or another prosthetic dental component. The abutment 1300 may be threadably connectable to the fastener body 300 so that the abutment 1300 may be received in the fastener body 300 after the fastener body 300 is implanted with a bone. Additionally, or alternatively, the abutment 1300 may be connected to the fastener body 300 prior to implantation on the fastener body 300 into the bone.

The abutment 1300 may include a distal portion 1310, a proximal portion 1315, and a central portion 1325 located between the distal portion 1310 and the proximal portion 1315. The distal portion 1310 may include a threaded portion 1305. The threaded portion 1305 may be configured to be threadably engage threaded socket 308 to secure the abutment 1300 to the fastener body 300.

The proximal portion 1315 may include a post portion 1320. The post portion 1320 may extend beyond the proximal end 301 of the fastener body 300, with the abutment 1300 secured to the fastener body 300. The post portion 1320 may provide a post and/or an anchor point for a dental crown 1500 (as shown in FIGS. 10A & 10B), a dental bridge, and/or another prosthetic dental component.

The proximal portion 1315 may be sized to be received in the internal pocket 309 of the fastener body 300 and may provide additional contact area between the abutment 1300 and the fastener body 300 to provide secure engagement between the two. The central portion 1325 may be sized to be rotatably received in the torque connection interface 306.

The post portion 1320 may be configured with a single flat, a double flat, a square, a hex, or another non-circular profile to facilitate transmission of a torque from a driver tool to the abutment 1300. Alternatively, the post portion 1320 may include a circular profile.

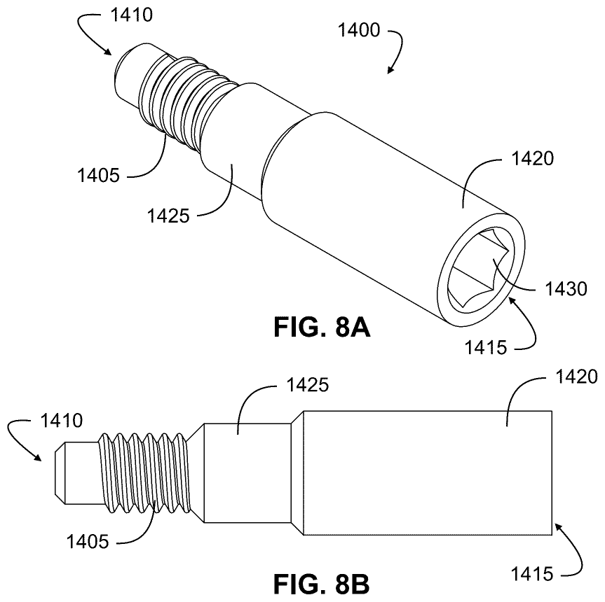

FIG. 8A is a perspective view of an abutment 1400 according to an embodiment of the present disclosure. FIG. 8B is a side view of the abutment 1400. Various parts of the abutment 1400 may be identical or similar to their counterparts on the abutment 1300 presented herein; these parts may not be described again here. All statements made regarding the abutment 1300 may apply to the abutment 1400 unless they would be contradicted by the differences between the two. The abutment 1400 may include a threaded portion 1405, a distal portion 1410, a proximal portion 1415, a post portion 1420, and a central portion 1425.

The proximal portion 1415 may include a torque connection interface 1430. The torque connection interface 1430 may be configured to receive a driver (not shown) configured to transfer torque to the abutment 1400 in order to drive the abutment 1400 into the fastener body 300. The torque connection interface 1430 may be configured as a hex, a square, a hexalobe, or another non-circular profile.

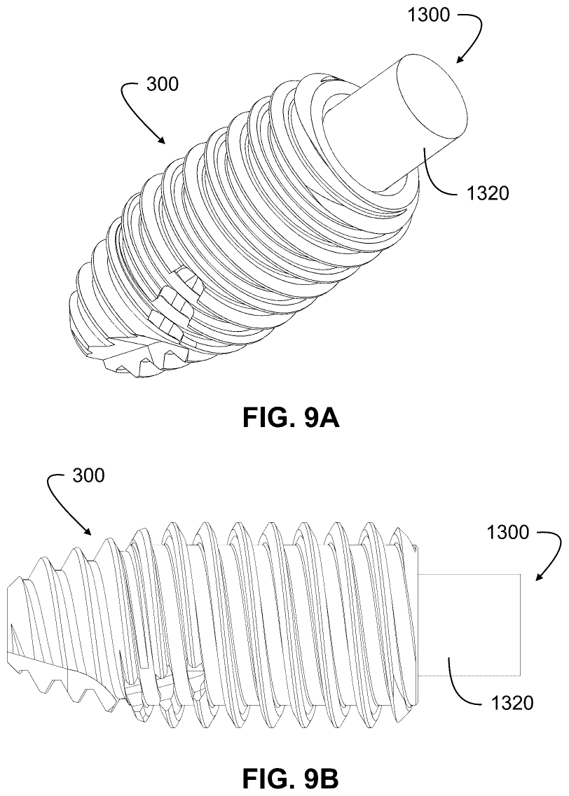

FIG. 9A is a perspective view of a fastener body 300 assembled with an abutment 1300 according to an embodiment of the present disclosure. FIG. 9B is a side view of the fastener body 300 assembled with the abutment 1300. The abutment 1300 may be received in the fastener body 300. The post portion 1320 may extend beyond the proximal end 301 of the fastener body 300, with the abutment 1300 secured to the fastener body 300. The post portion 1320 may provide a post and/or an anchor point for a dental crown 1500 (as shown in FIGS. 10A & 10B), a dental bridge, and/or another prosthetic dental component.

FIG. 10A is a perspective view of a fastener body 300 assembled with a dental crown 1500 according to an embodiment of the present disclosure. FIG. 10B is a side view of the fastener body 300 assembled with the dental crown 1500. The dental crown 1500 may be received on the abutment 1300. More specifically, the dental crown 1500 may be received on the post portion 1320 of the abutment 1300.

Alternatively, the dental crown 1500 may include a post that is received in the fastener body 300 without an abutment. The post may be secured to the fastener body 300 using cement, adhesive, and/or a mechanical connection.

The material(s) of any portion of a bone implant, joint replacement implant, fastener, bone disunion fastener, etc., described herein may include, but are not limited to: metals (e.g., titanium, cobalt, etc.), metal alloys (stainless steel, titanium alloy, nickel-titanium alloy, etc.), plastics, polymers, ceramics, PEEK, UHMWPE, composites, additive particles, textured surfaces, biologics, biomaterials, bone, etc.

The fastener body 300 may be one of a set of fasteners each having a different thread option described or contemplated herein. A surgical kit may include multiple fasteners/implants with any of the different fasteners/implants and thread options described or contemplated herein. A surgeon may select the appropriate fasteners/implants from the kit based on the particular loads to be applied and/or the quality of bone in which the fastener/implants are to be anchored.

It will be understood that any fastener/implant described or contemplated herein may include any thread configuration, feature, or morphology described or contemplated herein to achieve optimal fixation within a given bone/tissue. Moreover, it will also be understood that any fastener/implant described or contemplated herein may be utilized in conjunction with (or within) any system, method, or instrumentation described or contemplated herein.

Any of the fasteners described herein may be configured for removal and replacement during a revision procedure by simply unscrewing and removing the fastener from the bone/tissue in which the fastener resides. Moreover, the fasteners described herein may advantageously be removed from bone without removing any appreciable amount of bone during the removal process to preserve the bone. In this manner, fasteners may be mechanically integrated with the bone, while not being cemented to the bone or integrated via bony ingrowth, in order to provide an instant and removable connection between a fastener and a bone. Accordingly, revision procedures utilizing the fasteners described herein can result in less trauma to the bone and improved patient outcomes.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the present disclosure. This method of disclosure, however, is not to be interpreted as reflecting an intention that any embodiment requires more features than those expressly recited in that embodiment. Rather, inventive aspects lie in a combination of fewer than all features of any single foregoing disclosed embodiment.

Recitation of the term “first” with respect to a feature or element does not necessarily imply the existence of a second or additional such feature or element. Elements recited in means-plus-function format are intended to be construed in accordance with 35 U.S.C. § 112 (f). It will be apparent to those having skill in the art that changes may be made to the details of the above-described embodiments without departing from the underlying principles set forth herein.

The phrases “connected to,” “coupled to,” “engaged with,” and “in communication with” refer to any form of interaction between two or more entities, including mechanical, electrical, magnetic, electromagnetic, fluid, and thermal interaction. Two components may be functionally coupled to each other even though they are not in direct contact with each other. The term “coupled” can include components that are coupled to each other via integral formation, as well as components that are removably and/or non-removably coupled with each other. The term “abutting” refers to items that may be in direct physical contact with each other, although the items may not necessarily be attached together. The phrase “fluid communication” refers to two or more features that are connected such that a fluid within one feature is able to pass into another feature. Moreover, as defined herein the term “substantially” means within +/−20% of a target value, measurement, or desired characteristic.

While specific embodiments and applications of the present disclosure have been illustrated and described, it is to be understood that the scope of this disclosure is not limited to the precise configuration and components disclosed herein. Various modifications, changes, and variations which will be apparent to those skilled in the art may be made in the arrangement, operation, and details of the devices, systems, instruments, and methods disclosed herein.

1. A threaded dental implant comprising:
a fastener body defining a longitudinal axis, the fastener body comprising:
a proximal end comprising a threaded socket; and
a distal end; and
a first helical thread disposed about the fastener body along the longitudinal axis, the first helical thread comprising:
a first thread form comprising a first distal-facing side and a first proximal-facing side; and
a second thread form comprising a second distal-facing side and a second proximal-facing side;
wherein:
the first distal-facing side and the second proximal-facing side are generally concave;
the first proximal-facing side and the second distal-facing side are generally convex; and
the threaded socket is configured to receive a dental component.

2. The threaded dental implant of claim 1, wherein the fastener body comprises a distal portion that is tapered such that a first diameter at the distal end is less than a second diameter at the proximal end.

3. The threaded dental implant of claim 2, wherein the distal portion comprises a second helical thread along the longitudinal axis.

4. The threaded dental implant of claim 3, wherein the second helical thread comprises a third thread form that is different than the first thread form and the second thread form.

5. The threaded dental implant of claim 4, wherein the third thread form lacks a concave side.

6. The threaded dental implant of claim 4, wherein the first helical thread and the second helical thread extend along a continuous helical path.

7. The threaded dental implant of claim 1, wherein the first helical thread comprises a first thread profile at the distal end and a second thread profile, different than the first thread profile, at the proximal end.

8. The threaded dental implant of claim 1, wherein the proximal end comprises a flat proximal surface perpendicular to the longitudinal axis.

9. The threaded dental implant of claim 1, wherein the distal portion comprises a second helical thread comprising a thread form lacking a concave side and the proximal portion comprises a third helical thread comprising a micro-thread form.

10. A threaded dental implant comprising:
a fastener body defining a longitudinal axis, the fastener body comprising:
a proximal end comprising a threaded socket; and
a distal portion comprising a tapered portion comprising a first helical thread along the longitudinal axis; and
a second helical thread disposed about the fastener body along the longitudinal axis, the second helical thread comprising an even number of thread leads;
wherein:
an odd numbered thread lead comprises a first thread form; and
an even numbered thread lead comprises a second thread form that is different than the first thread form.

11. The threaded dental implant of claim 10, wherein the first helical thread comprises a third thread form that is different than the first thread form and the second thread form.

12. The threaded dental implant of claim 11, wherein the third thread form lacks a concave side.

13. The threaded dental implant of claim 11, wherein the first helical thread and the second helical thread extend along a continuous helical path with a constant pitch.

14. The threaded dental implant of claim 10, wherein the threaded socket is configured to receive a dental component.

15. The threaded dental implant of claim 10, wherein the proximal portion comprises a third helical thread comprising a micro-thread form.

16. A threaded dental implant comprising:
a fastener body defining a longitudinal axis, the fastener body comprising:
a proximal end comprising a threaded socket; and
a distal end; and
a helical thread disposed about the fastener body along the longitudinal axis;
wherein:
the helical thread comprises a first thread profile and a second thread profile; and
at least one of the first thread profile and the second thread profile comprises a concave side.

17. The threaded dental implant of claim 16, wherein the first thread profile comprises a dual-lead thread comprising a first thread form comprising a concave side and a second thread form comprising a concave side.

18. The threaded dental implant of claim 16, wherein the second thread profile that lacks a concave side.

19. The threaded dental implant of claim 18, wherein the first thread profile extends from near the proximal end to the second thread profile and the second thread profile extends from the first thread profile to near the distal end.

20. The threaded dental implant of claim 19, wherein the fastener body further comprises a tapered portion proximate the distal end, the tapered portion comprising the second thread profile.

21. The threaded dental implant of claim 16, wherein the first thread profile and the second thread profile extend along a continuous helical path with a constant pitch.

22. The threaded dental implant of claim 16, wherein the threaded socket is configured to receive a dental component.
